(19) United States
(12) Patent Application Publication
(10) Pub. No.: US 2025/0176474 A1
(43) Pub. Date: Jun. 5, 2025

(54) POT AND METHOD FOR GROWING PLANTS

(71) Applicant: AGRO INNOVATION INTERNATIONAL, SAINT MALO (FR)

(72) Inventors: Bastien BILLIOT, SAINT MALO (FR); Sylvain PLUCHON, SAINT MALO (FR)

(73) Assignee: AGRO INNOVATION INTERNATIONAL, SAINT MALO (FR)

(21) Appl. No.: 18/862,066

(22) PCT Filed: May 5, 2023
(86) PCT No.: PCT/FR2023/000084

§ 371 Date: Oct. 31, 2024

(30) Foreign Application Priority Data
May 5, 2022 (FR) 2204286

(51) Int. Cl. A01G 9/02; A01G 27/00

(52) U.S. Cl. CPC A01G 9/02; A01G 27/001

(57) ABSTRACT

A pot for cultivating a plant, including a planting area and a root guide channel extending between a fluid inlet and a fluid outlet and configured to guide the development of roots downstream of the planting area, said channel being accessible to the roots of a plant planted in the planting area, the channel winding around a guideline and making more than one revolution around said guideline between the inlet and the outlet.

### CROSS-REFERENCE TO RELATED APPLICATION(S)

This is a National Stage Application under 35 U.S.C. § 371 of International Application No. PCT/FR2023/000084 filed May 5, 2023 which claims priority to French Patent Application No. 2204286, filed on May 5, 2022, the entireties of which are incorporated herein by reference.

### TECHNICAL FIELD

The present disclosure relates to a pot for cultivating a plant and to a method for cultivating a plant. This pot and this method can be used for many types of plants, not only on Earth but also in space.

### PRIOR ART

Food autonomy is a constant need of our societies. On Earth, this problem has been solved in many ways, thanks to the richness and variety of the environment at our disposal. However, in some constrained environments, specific solutions must be implemented, particularly for the cultivation of plants.

Typically, in space, hydroponics is generally used, which is a technique in which the absence of a solid nutrient substrate is compensated by the fact that the plants are bathed in a nutrient solution. However, this technique has several drawbacks.

On the one hand, the presence of a nutrient solution bath poses water management problems, both regarding the large amounts of water necessary and the energy required to move or regenerate the nutrient solution.

On the other hand, the presence of a nutrient solution bath is synonymous with bulkiness while the space available is generally limited. This bulkiness is accentuated by the fact that to ensure good reproduction of the plants, and therefore sustainable food autonomy, it is necessary to let the plants develop to an advanced stage where they take up a relatively large space.

There is therefore a need for a new type of pot and method for cultivating plants.

### DISCLOSURE OF THE INVENTION

For this purpose, the present disclosure relates to a pot for cultivating a plant, comprising a planting area and a root guide channel extending between a fluid inlet and a fluid outlet and configured to guide the development of roots downstream of the planting area, said channel being accessible to the roots of a plant planted in the planting area, the channel winding around a guideline and making more than one revolution around said guideline between the inlet and the outlet.

Within the meaning of the present disclosure, a plant generically designates a plant at any stage of its development, in particular at the seed stage, at the pre-germinated seed stage, at the germination stage, a plant before harvest, a plant after harvest, etc. Within the framework of the present disclosure, the plant has a rooting system capable of developing in the root guide channel and a vegetative system capable of developing from the planting area. Particularly, the plant can be a food plant, that is to say a plant whose leaves, stems, roots and/or fruits are edible.

Without loss of generality, the fluid will be subsequently considered to be a nutrient solution for the plant, typically an aqueous solution.

Downstream means in a direction from the fluid inlet to the fluid outlet, the outlet being further downstream than the inlet.

The guideline can be rectilinear, curved or a broken line comprising straight line segments and/or conjoined arcs. The winding of the channel around this guideline can follow a curved winding, but can also follow a broken line comprising straight line segments and/or conjoined arcs. Thus, the channel makes more than one revolution around the guideline between the inlet and the outlet, this revolution can have a generally substantially circular, polygonal, piecewise curved, broken line shape or the like. The revolutions can possibly differ from each other, for example in their shape or size.

In most cases, the channel therefore follows a three-dimensional path around the guideline. However, the winding can also be degenerate in the mathematical sense of the term, in the case where the path is not three-dimensional but two-dimensional. For example, if the path of the channel is restricted to a plane (or more generally a surface) containing the guideline, then the channel can meander around the guideline, the serpentine (rectilinear or non-rectilinear) segments succeeding one another along the guideline. According to another example, if the channel path is restricted to a plane (or more generally a surface) transverse to the guideline, then the channel can form a kind of spiral (with rectilinear or curved segments).

In contrast, a one-dimensional channel is not considered as winding around the guideline, because it simply follows the guideline, without any winding.

Whether the winding is two-dimensional or three-dimensional, the channel extends over several stages, the bulkiness of each stage overlapping at least partially with the bulkiness of another stage along at least one direction, for example the direction of the guideline or a direction transverse to the guideline.

The channel is configured to guide the fluid arriving through the fluid inlet to the fluid outlet. In addition to the geometric limits imposed by the channel itself, the roots of the plant, which are attracted by this fluid flow and seek to follow it, are thus guided by the channel, from the planting area to the outlet, along the shape of the winding channel. The pot therefore does not require a bath using a large amount of nutrient solution, but only a low flow of this solution. Thus, the energy needs of the pot, for example the power supply needs to operate a pump, are reduced.

In addition, such a channel configuration therefore makes it possible, with a relatively small amount of fluid, to guide the roots along a compact path, which makes it possible to minimize their bulkiness and therefore the overall bulkiness of the plant, even if the plant is cultivated to an advanced growth stage.

In some embodiments, the planting area is located along the channel, between the inlet and the outlet. Thus, all the roots can be properly irrigated, even on their portion closest to the planting area.

In some embodiments, the channel is provided with means for retaining a water-soluble filler. The retention means can be a housing, an obstacle such as a grid, a support, or any member for maintaining the water-soluble filler, apart from its gradual dissolution, at the desired location. The water-soluble filler can be a nutrient filler.

In some embodiments, the retention means are provided between the fluid inlet and the planting area. Thus, the fluid can be filled with part of the water-soluble filler before reaching the planting area, and therefore the roots.

In some embodiments, the planting area is provided closer to the guideline than to the outside of the pot. The proximity to the guideline can in particular be assessed in a direction transverse to the guideline. Thanks to these arrangements, the planting area is relatively centered relative to the entire bulkiness of the pot. It follows that the non-rooting part (also called aerial part, which may correspond to the vegetative system) of the plant develops to the maximum in the extension of the bulkiness of the pot and the additional bulkiness generated by the plant is limited.

In some embodiments, the channel is configured to allow the gravity flow of liquid between the inlet and the outlet, in particular from the inlet to the outlet. Such a flow, a consequence of the surrounding gravity or microgravity, allows the fluid to irrigate all of the roots, with a reduced energy cost. Furthermore, the gravity promotes the development of the roots downwards, that is to say towards the outlet, and contributes to their guiding by the channel.

Alternatively or additionally, the channel may form one or several basins between the inlet and the outlet, these basins being able to retain the fluid despite the flow between the inlet and the outlet. Such basins allow the retention of part of the fluid in case of interruption of the flow and/or promote the development of microorganisms, both of these aspects promoting the growth of the plant.

In some embodiments, with reference to a radius-azimuth-dimension reference frame having the guideline as axis, a parameterization of the channel is such that the azimuth takes the same value several times and the dimension evolves in a monotonic manner. The radius (r)—azimuth (θ)—dimension (z) reference frame, sometimes called cylindrical reference frame when the axis is rectilinear, and which will subsequently be called a pseudo-cylindrical reference frame in the general case, is such that the axis of the dimensions is formed by the guideline. The radius r measures the distance (in the mathematical sense, that is to say the smallest distance) from a point to the axis, the azimuth θ measures the angle relative to a given direction of zero azimuth, and the dimension z measures the curvilinear abscissa along the guideline.

In such a reference frame, the path followed by the channel, that is to say apart from the shape of the channel itself in cross section, is such that the azimuth takes the same value several times, which reflects the fact that the channel winds around the guideline, while the dimension evolves in a monotonic manner, that is to say either increasing or decreasing according to the orientation of the axis, which reflects the fact that the channel has several stages in the direction of the guideline.

In some embodiments, the dimension evolves in a strictly monotonic manner, which facilitates the flow between the inlet and the outlet. Conversely, when the dimension evolves in a non-strict monotonic manner, the presence of some zero slope sections can contribute to creating the basins mentioned above. The dimension, even monotonic, does not however necessarily evolve in a regular or even constant manner. For example, an inlet portion of the channel may have a relatively steep slope, whose dimension evolves quickly, while a portion of the channel further from the inlet may have a less steep slope, whose dimension evolves less quickly. The steep slope makes it possible to quickly guide the roots towards the inside of the pot so that they come out as little as possible, while a less steep slope offers better compactness and makes it possible to enclose the plant in a controlled environment, in particular in terms of humidity as will be seen later.

In some embodiments, the channel has a general helix shape. In the pseudo-cylindrical reference frame, a circular helix is characterized by a constant radius r, an azimuth θ=at and a dimension z=bt, where a=−1 or +1, b is any constant defining the pitch of the helix and t is a parameter. Other helices are envisaged, such as elliptical, conical, spherical helices, or even paraboloid helices. More generally, the radius r may not be constant but monotonic or oscillate in a given range. Similarly, the azimuth θ may not be monotonic but oscillate in a given range, or even alternatively take two opposite values in the case of a two-dimensional path of the channel. The guideline may be rectilinear.

In some embodiments, the pot further comprises a core extending along the guideline. The core may extend inside the path followed by the channel.

In some embodiments, the core supports the channel. Indeed, the core, of relatively simple shape, can reinforce the channel whose shape is dictated by its function of guiding the roots and of small bulkiness. Thus, the pot is more robust and easier to manipulate.

In some embodiments, at least one end of the core includes fixing means such as a thread or a tapping. Other fixing means can be envisaged, such as an orifice (for example for the passage of a pin), a protuberance intended to cooperate with a corresponding shape, etc. The fixing means make it possible to easily manipulate the pot by means of a suitable tooling, for example an articulated arm.

In some embodiments, the channel has a porous bottom. The bottom designates, in a gravity environment, the low part of the channel, or more generally the part of the channel provided to collect the fluid flow. This bottom can be porous due to the structure and/or to the very material of the channel, or can comprise a porous coating. The pores allow the development of microorganisms. The growth of the plant is therefore promoted. When the porosity is linked to the material of the channel, not only is the bottom of the channel porous, but the channel itself may be porous, preferably entirely porous. Such porosity of the bottom, of the channel or of the entire pot makes it possible, in combination with the winding of the channel on itself, to trap the ambient humidity and the microorganisms and, consequently, to space out the phases of active hydration of the plant, that is to say the phases where a fluid actually flows along the channel. The efficiency of use of the fluid is therefore improved, which allows energy savings. Furthermore, dry phases have a detrimental effect on the plant; maintaining ambient humidity for longer therefore also promotes the growth of the plant.

In some embodiments, the channel has a closed cross-section. Thus, the roots are completely guided and the bulkiness finally obtained, including the roots, can be better predicted. Furthermore, the roots are completely protected from possible radiation.

Alternatively, in some embodiments, the channel is, in cross-section, open opposite to the bottom. Thus, the channel can take the form of a drill. An open channel facilitates the observation of the roots, the measurement using sensors and the cleaning of the roots once the plant has reached maturity, and requires less material for the manufacture of the channel.

In some embodiments, the pot further comprises an instrument such as an image sensor, a lighting element or a microfluidic chip. Such an instrument, or a different instrument, makes it possible to monitor or stimulate the growth of the plant. The instrument can be integrated into the pot, optionally by being housed in a reservation provided for this purpose.

The present disclosure also relates to a method for cultivating a plant, comprising planting the plant in the planting area of a pot as described above, and supplying the inlet of the channel with fluid, so that the fluid flows towards the outlet while reaching the roots of the plant. Such a method makes it possible to cultivate a plant economically while benefiting from the advantages provided by the pot, detailed above. The pot can have any one of the characteristics previously described.

In some embodiments, the supply is intermittent. Thus, the supply can be adapted to the availability of energy, for example to power a pump. Furthermore, when several pots are present, they may be supplied alternately, which sufficiently stimulates the growth of the plants while saving energy.

The present disclosure also relates to a method for manufacturing a pot as described above, the method comprising making the pot by additive manufacturing. The additive manufacturing methods used may depend on the material used to construct the pot and comprise, for example, fused deposition modeling (FDM), stereolithography (SLA), and selective laser sintering (SLS).

### BRIEF DESCRIPTION OF THE DRAWINGS

Other characteristics and advantages of the object of the present disclosure will emerge from the following description of embodiments, given as non-limiting examples, with reference to the appended figures.

FIG. 1 illustrates a perspective top view of a pot for cultivating a plant according to a first embodiment.

FIG. 2 is a sectional view of the pot of FIG. 1 along the plane II-II.

FIG. 3 illustrates a perspective bottom view of the pot according to the first embodiment.

FIG. 4 illustrates a perspective top view of a pot for cultivating a plant according to a second embodiment.

FIG. 5 is a sectional view of the pot of FIG. 4 along the plane V-V.

FIG. 6 is a perspective view of a plant fixing accessory according to one embodiment.

FIG. 7 is a block diagram illustrating a method for cultivating a plant according to one embodiment.

FIG. 8 is a block diagram illustrating a method for manufacturing a pot according to one embodiment.

### DETAILED DESCRIPTION

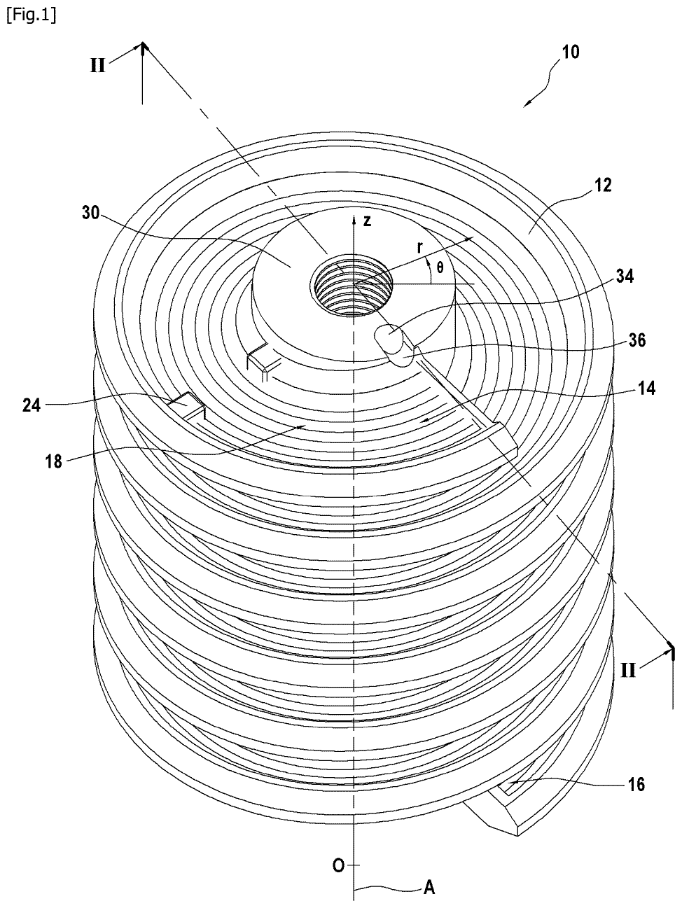

A pot 10 for cultivating a plant according to a first embodiment is illustrated in FIGS. 1 to 3. The plants concerned by the present pot can be any plants for food or non-food purposes, for example salads, radishes, peas, beans, rapeseed, corn, wheat, tomatoes, etc.

The pot 10 extends generally along a guideline A. The guideline A is here rectilinear but in the general case, it could be curved or defined piecewise, as disclosed previously. In this embodiment, the pot 10 extends longitudinally along the guideline A. The guideline A may be a midline of the pot 10.

The guideline A can be taken as the dimension axis of a pseudo-cylindrical, or in this case cylindrical, reference frame, as illustrated in FIG. 1. As indicated previously, for a given point, the radius r measures the distance from this point to the guideline A, the azimuth θ measures the angle between a given direction of zero azimuth and a radius connecting the point and the guideline A, and the dimension z measures the curvilinear abscissa of the projection of this point along the guideline A, from an origin O positioned arbitrarily on the guideline A.

The pot 10 comprises a channel 12 for guiding the roots of the plant intended to be received in the pot 10. The channel 12 extends between a fluid inlet 14 and a fluid outlet 16, the fluid being able to travel through the channel 12 from the inlet 14 to the outlet 16. In this embodiment, the channel 12 has a shape and a path that allow the gravity flow of liquid between the inlet 14 and the outlet 16, as will be described later. The channel 12 is here materially continuous, but it is possible to provide for a channel 12 in several discontinuous (rectilinear or non-rectilinear) segments arranged so that the fluid flows from one segment to the other by gravity. Such a configuration can be relevant in particular for the insertion of elements (sensors, chips, etc.) between the segments.

The pot 10 moreover comprises a planting area 18. The planting area 18 is configured to accommodate the plant, which includes in particular the proximal end of its roots. In this case, the planting area 18 is a part provided along the channel 12, or even directly in the channel 12. The planting area 18 is located in particular between the inlet 14 and the outlet 16. However, as a variant, the planting area could be located upstream of the inlet 14, or even upstream of the channel 12.

The plant may be maintained in the planting area 18 by means known per se, for example by being germinated in a porous support of the foam type or equivalent, this support then being maintained in the planting area by simple friction or by ad hoc fixing means. In other embodiments, the planting area 18 itself may be configured so as to retain the plant and/or its support.

Thus, the channel 12 is accessible to the roots of the plant planted in the planting area 18, and the channel 12 is configured to guide the development of these roots downstream of the planting area 18. These roots may, after a sufficiently long time, develop from the planting area 18 to the outlet 16.

The path of the channel 12, that is to say its evolution in space independently of its own shape (typically independently of its section transversely to said evolution), can be described in the pseudo-cylindrical reference frame: this is referred to as a parameterization of the channel 12. In the following, unless otherwise stated or emerging from the context, the coordinates r-θ-z refer to the path of the channel 12 in the pseudo-cylindrical reference frame.

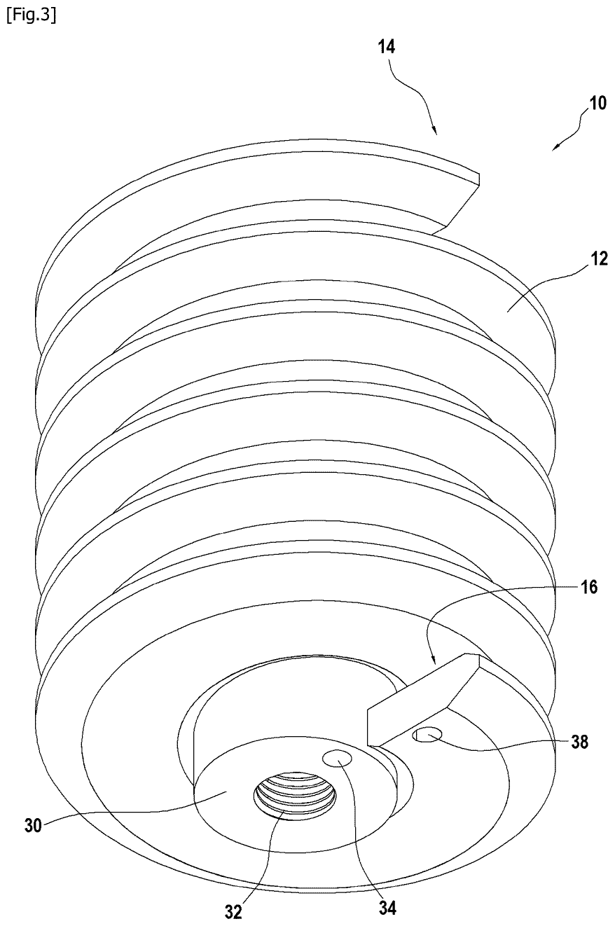

As it emerges from FIGS. 1 and 3 particularly the channel 12 winds around the guideline A: the channel 12 passes from one side to the other of the guideline A, in this case continuously. The channel 12 may bypass the guideline A as illustrated in FIGS. 1 to 3. However, as a variant, the channel 12 could meander around the guideline A and pass from one side to the other of the guideline A by crossing the guideline A, for example in a succession of segments inclined alternatively in one direction then in the other.

Thus, when the channel 12 is traveled from the inlet 14 to the outlet 16, the azimuth θ varies.

Furthermore, the channel 12 makes more than one revolution around the guideline A between the inlet 14 and the outlet 16. In other words, the azimuth θ takes the same value several times, having taken at least one different value between two occurrences of the same value. In this case, the channel 12 makes six revolutions around the guideline A, however any number of revolutions, integer or not, strictly greater than 1, is envisaged. The length of the channel 12, and consequently the other parameters of the pot 10, can be dimensioned according to the plant to be grown there. Particularly, the channel 12 can be provided sufficiently long to allow the development of the plant until a seed-setting stage.

In this example, the dimension z evolves in a monotonic manner, here proportionally to the azimuth θ, which gives the channel 12 a general helix shape, as shown in FIGS. 1 and 3, a fortiori insofar as the radius r is constant. The inventors have determined that a general helix shape would not only ensure good compactness of the channel 12 but also good balance and increased robustness of the pot 10. However, other general shapes of the pot 10 are envisaged, in particular in which the radius r could not be constant and/or the dimension z could evolve in a monotonic but different manner, linked or not to the azimuth θ, or even non-monotonic, which would lead to other shapes of the channel 12, each shape having its own advantages. For example, a non-strictly monotonic evolution of the dimension z would make it possible to arrange baths, or liquid retention areas, between the inlet 14 and the outlet 16. According to another example, an piecewise affine evolution of the dimension would make it possible to arrange channel portions with different slopes, for example with a relatively steep slope on the side of the inlet of the channel, then a less steep slope on a portion of the channel closer to the outlet.

The cylindrical helix that guides the path of the channel 12 represented in FIGS. 1 to 3 has a pitch comprised between 1 and 8 centimeters (cm), preferably between 2 and 4 cm, this pitch conventionally corresponding to the distance between two successive revolutions, measured along the guideline A.

In any event, the fact that the channel 12 winds around the guideline A, making more than one revolution, makes it possible to guide the roots of the plant on a deliberately compact path, in order to limit the bulkiness of the pot 10 while allowing maximum development of the plant. For example, the pot 10 according to the first embodiment makes it possible, with a height of 20 cm along the guideline A, to obtain a path length (curvilinear abscissa of the channel 12) of the order of 2 meters (m) for the development of the roots. Generally, the height of the pot may be less than 2 m, or even 1 m.

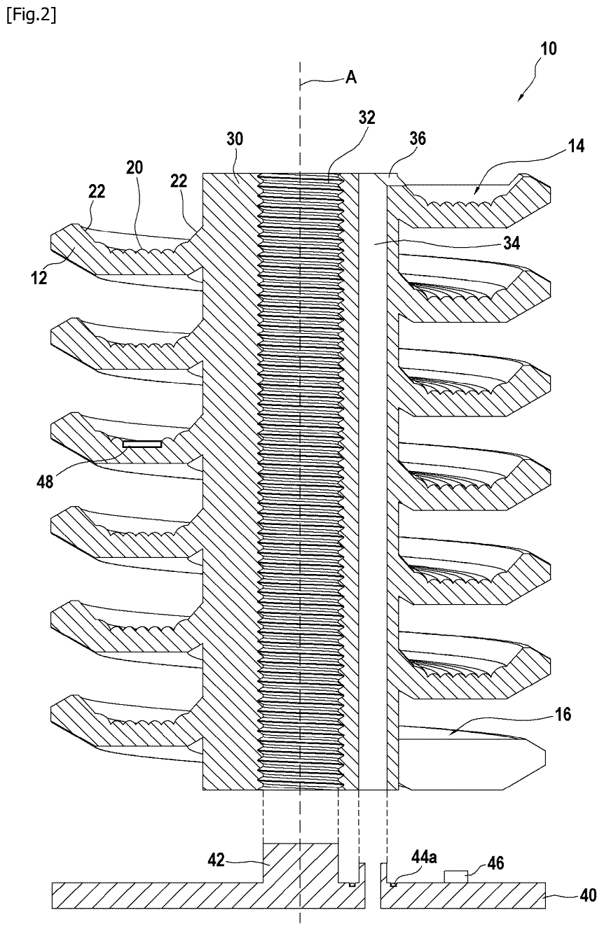

The cross-section of the channel 12 can be observed more clearly in FIG. 2. The cross-section of the channel 12 refers to its cross-section transverse to its path. In this case, the channel 12 has a bowl-shaped cross-section. The channel 12 has a bottom 20, able to collect the liquid runoff from the inlet 14 to the outlet 16, and at least one lateral rim 22, here two such rims, framing the bottom 20 and configured to prevent fluid overflow and to concentrate the liquid runoff on the bottom 20, which prevents the roots from lodging on a single side of the channel 12. A radially inner rim 22 (that is to say the one closest to the guideline A) is provided here but may not exist, the anti-overflow function already being ensured by the core 30 which will be described later.

In this example, the channel 12 is, in cross-section, open opposite to the bottom 20. In other words, the radially outer rim 22 (that is to say, the one furthest from the guideline A) has a free end, and the bottom 20 is accessible from the outside of the channel 12. This simplifies the cleaning of the channel 12 when a plant is removed from the pot, promotes the visual or instrumented monitoring of the growth of the plant, promotes oxygenation of the roots and requires less material for the manufacture of the pot 10. Furthermore, the inventors have discovered that the roots are sufficiently attracted by the fluid running off on the bottom 20 and develop naturally in the vicinity of the bottom 20, without excessive overflow through the open upper part of the channel 12.

According to one example, the width of the channel 12 accessible to the roots may be comprised between 2 and 10 cm, preferably between 3 and 6 cm.

The bottom 20 may be porous. The porosity of the bottom 20 may be obtained thanks to the characteristics of the material forming the bottom itself, which characteristics may optionally result from one particular method, and/or thanks to an additional layer, for example 0.1 to 2 millimeters (mm) thick, preferably 0.5 to 1 mm thick, configured to form the surface part of the bottom 20. The porosity may be microporosity. The porosity may be homogeneous. The average pore diameter may be adapted to the desired application, for example optimized for the development of one or several given microorganisms. The porosity may concern not only the bottom 20 of the channel 12, but also extend to other parts of the channel 12 such as the lateral rim 22, the core 30 or the reverse side of the channel 12 which faces the bottom 20 of the immediately lower stage.

Such porosity makes it possible to trap microorganisms, in particular microorganisms that fix nitrogen present in the air and transform it into ammonium that can be absorbed by the plant.

Furthermore, as illustrated in FIGS. 1 and 2, the bottom 20 may be ridged to promote the attachment of the bacteria and other microorganisms. The ridges may be parallel to the flow so as not to disturb it. In this case, the ridges are formed by bosses protruding from the bottom 20 of the channel 12, extending over all or part of the channel 12.

In order to feed the plant, nutrients may be added to the fluid entering through the inlet 14, whether or not this fluid itself already contains nutrients. For this purpose, the channel 12 may be provided with means for retaining a water-soluble filler. In the example of FIG. 1, these retention means comprise at least one stop 24, in this case two such stops, protruding towards the inside of the channel 12 from the bottom 20 and/or from a rim 22. The stops 24 limit the passage section of the channel 12 in order to retain a filler, in particular a solid filler. The stops 24 are positioned downstream of the inlet 14. The filler, water-soluble or equivalent, is then gradually dissolved by the flow of fluid coming from the inlet 14. The filler may also have a multi-layer structure, for example be designed so that its outer layers, accessible from the start, comprise nutrients useful to the plant during its early stages of development, while the more inner layers, which are only accessible after a certain erosion of the filler, comprise nutrients useful to the plant during its later development. The water-soluble filler itself may take the form of a multi-layer pipe, a grid shape, or any other suitable shape.

In this embodiment, the planting area 18 is provided upstream of the stops 24. The filler may then be placed upstream or downstream of the planting area 18, the nutrients contained in the filler benefiting in both cases at least the majority of the roots. Independently of the stops 24, the filler could be maintained by the plant itself.

According to one variant, the stops 24, or more generally the retention means, may be provided between the inlet 14 and the planting area 18. Then, all of the roots benefit from the nutrients released by the filler.

As mentioned above, the pot 10 may also comprise a core 30. The core 30 extends along the guideline A. Thus, the core 30 may be rectilinear. In this case, the core 30 has the general shape of a cylinder with a circular base.

The core 30 may support the channel 12 to reinforce the pot 10. As shown for example in FIG. 2, the inner rim 22 of the channel 12 may be fixed to the core 30. In the example represented, the core 30 and the channel 12 are made of a single piece and are integral, as will be detailed later.

The core 30 may be provided with fixing means 32, in this case a tapping. The tapping may also form a coupling means. Although this tapping will be described later, the properties indicated extend to any envisaged fixing or coupling means.

The tapping 30 may be provided at least at one end of the core 30, for example its end on the side of the inlet 14 and/or its end on the side of the outlet 16. In this case, the tapping is provided over the entire length of the core 30, and may be a through tapping. The through nature of the tapping may allow the passage, from one side to the other of the core 30, of instruments such as a stake, a cable, etc.

The fixing means 32 may be used to match the core 30, and more generally the pot 10, with accessories. For example, it is possible to attach to the pot 10, via the fixing means 32, a manipulation handle, possibly manipulable by a robotic arm, a lighting system, a stake, etc.

Moreover, the fixing means 32 may be used to associate several pots together, which makes it possible to manufacture the same pot 10 in several pieces, the fluid outlet of a pot then being able to be put in communication with the fluid inlet of the adjacent pot.

The core 30 may also comprise a supply conduit 34 for supplying the fluid inlet 14. The supply conduit 34 can extend substantially over the entire length of the core 30, from its end on the side of the outlet 16 and to its end on the side of the inlet 14. In the present embodiment, the supply conduit 34 opens out onto a cannula 36, in this case a radial cannula, which connects the supply conduit 34 to the fluid inlet 14 of the channel 12. Thus, the supply of fluid to the pot 10, via the supply conduit 34, and the discharge of the fluid from the pot 10, via a discharge conduit 38 onto which the fluid outlet 16 opens out, may be provided on the same side of the pot 10 (in this case the end on the side of the outlet), which limits the bulkiness of the ancillary systems. Furthermore, the fact that this side is the side opposite to the planting area 18 makes it possible to free up space for the growth of the aerial part of the plant.

As it appears from FIG. 2, the pot 10 may also be mounted on a base 40. The base 40 is here detachable from the pot 10. Although it is represented here as an individual base for a single pot 10, the base 40 may be larger and common to several pots 10.

The base 40 may comprise a support 42 for holding the pot 10, this support 42 cooperating for example with the aforementioned fixing means 32. In this case, the support 42 is a stud, for example not threaded, which engages in the tapping of the core 30.

Moreover, the base 40 may comprise fluid connectors 44, 46 respectively intended to supply the inlet 14, namely here the supply conduit 34, and to discharge the fluid from the outlet 16, namely here the discharge conduit 38. Ad hoc seals 44a may be provided to make a sealing between each connector 44, 46 and the respective conduit with which it engages.

The base may be an opacifying and/or anti-radiation base. Moreover, the pot 10 may itself be placed in an opacifying and/or anti-radiation housing, for example a cylindrical housing into which the pot 10 is inserted. Within the meaning of the present disclosure, an anti-radiation element is able to stop a radiation or at least reduce its intensity by several orders of magnitude. The targeted radiation can be, for example, an ultraviolet radiation.

Optionally, the pot 10 may comprise an instrument such as an image sensor, a lighting element or a microfluidic chip. These instruments, whose list is not exhaustive, may be provided on the pot 10 at a location corresponding to their function. For example, the lighting elements may be fixed on the back side of the channel 12, so that the lighting mounted on a stage illuminates the adjacent stage (here, lower stage). The lighting may be specific: fluorescence, black light, etc. According to another example, illustrated in FIG. 2, the channel 12 may have a reservation to house a sensor, in this case a microfluidic chip. Moreover, the image sensors include for example an RGB, monochrome, multispectral, infrared sensor, etc.

Overall, the pot 10 may be rigid, that is to say more rigid than the roots intended to develop therein. The material for the pot 10 may be chosen and/or the thickness of the walls of the pot 10 may be dimensioned for this purpose. For example, the deformation of the pot 10 during the growth of the plant may be zero or invisible to the naked eye.

The pot 10 may be made of various materials, such as polymers or composites. In one embodiment, the material may comprise regolith, for example the material may comprise a matrix comprising, or even consisting of, regolith and plastic material such as polyhydroxyalkanoate (PHA). Regolith-based matrices are known per se; it is recalled that regolith designates, on planets without atmosphere or natural satellites such as the Moon, the layer of dust produced by the impact of meteorites and by the solar wind on the surface. Regolith can also be obtained by synthesis. More generally, the material of the pot may be non-water-soluble, and optionally biodegradable, typically in bio-sourced compost which allows the degradation of the pot. Other materials envisaged are for example “Teflon” (registered trademark).

It is known that the regolith can have properties harmful to the vegetation growth, because of the formation of perchlorates under the effect of radiation, these perchlorates generating toxicity for the plant. This effect, if proven, can be overcome by the fact that the surface layer of the bottom 20, optionally porous, may have a different composition which is non-toxic for the plants. The surface layer of the bottom 20 then forms a physical barrier between the regolith and the roots. Optionally, in addition, anti-perchlorate compounds may be incorporated into said layer, a fortiori when this layer is porous. For example, the anti-perchlorate compound may be chosen among an agent providing nitrates limiting the toxicity of perchlorate, an agent whose formulation makes possible the incorporation of bacteria inhibiting the reduction of perchlorate, and/or a molecule making it possible to inhibit nitrate reductase.

The pot 10 and/or the aforementioned surface layer may also be manufactured using a composite material one of the components of which is water-soluble. Then, upon fluid passage, the water-soluble component is dissolved and the composite material becomes microporous.

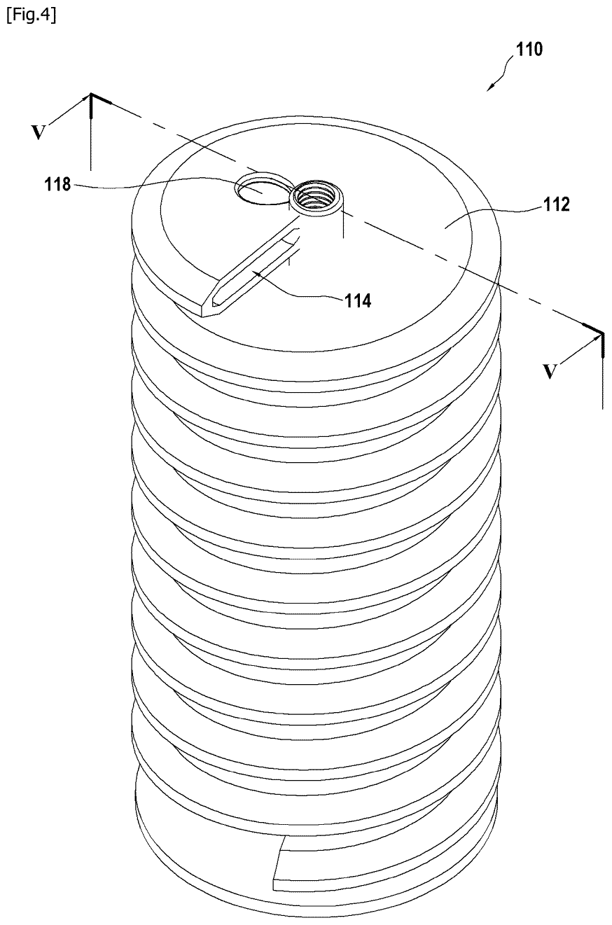

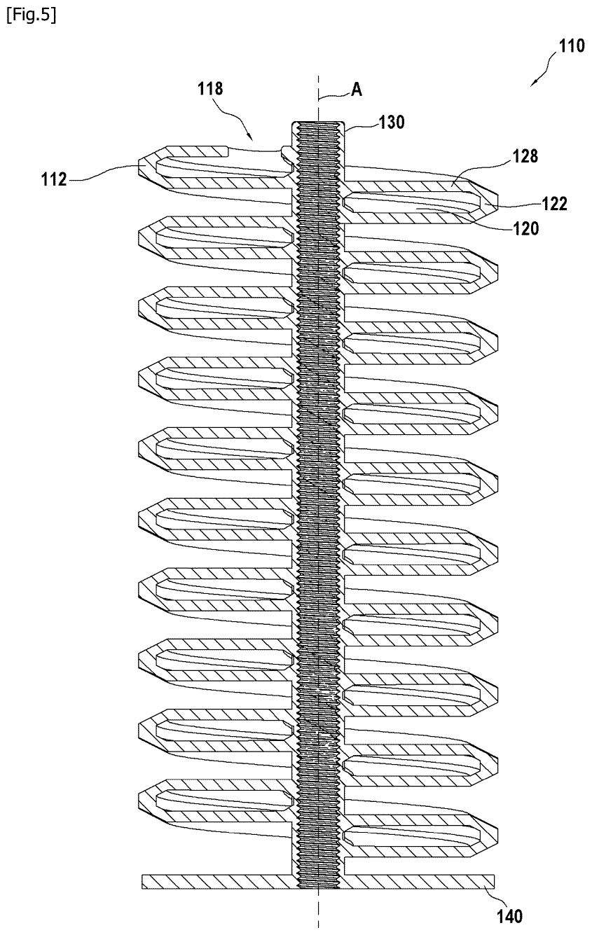

FIGS. 4 and 5 show a pot for cultivating a plant according to a second embodiment. In these figures, the elements corresponding or identical to those of the first embodiment will receive the same reference sign, with the exception of the hundreds digit, and will not be described again.

The pot 110 illustrated in FIGS. 4 and 5 differs from the pot 10 according to the first embodiment in that the channel 112 has a closed cross-section: a roof 128 is provided opposite to the bottom 120. The roof 128 and the bottom 120 may meet on the one hand at the outer rim 122, on the other hand at the core 130.

The space separating the bottom 120 from the roof 128 may be less than 1 cm, preferably less than 5 mm.

In this embodiment, the planting area 118 is materialized by an orifice provided in the roof 128, in order to allow the vegetative system of the plant to pass, particularly the stem and/or the leaves of the plant. As illustrated in FIGS. 4 and 5, the planting area 118 may be provided closer to the guideline A than to the outside of the pot 110. For example, the planting area 118 is closer to the core 130 than to the outer rim 122.

The means for maintaining a water-soluble filler may here take the form of a grid mounted in the channel 112, transversely to the channel 112, for example just upstream of the planting area 118. The water-soluble filler is then retained between the inlet 114 and the grid. However, stops or other means, as in the previous embodiment, may also be envisaged.

Unlike the pot 10 according to the first embodiment, the pot 110 according to the second embodiment, independently of its other characteristics, does not comprise any particular means for supplying the inlet 114 with fluid. In other words, the supply of the inlet 114 may be an outer supply, for example a hose whose tip would be adapted to the shape of the inlet 114.

Similarly, the discharge 38 of the first embodiment is replaced, here, by an outer discharge not illustrated.

In this embodiment, the bottom 120 may be smooth, particularly devoid of the previously described ridges.

Moreover, the base 140 is here made in one piece with the pot 110. Insofar as the fluid supply and discharge do not pass through the pot 110, the base 140 can be simplified and is essentially used to hold the pot 110. Furthermore, the core 130 may be thinned, which frees up more space for the channel 112.

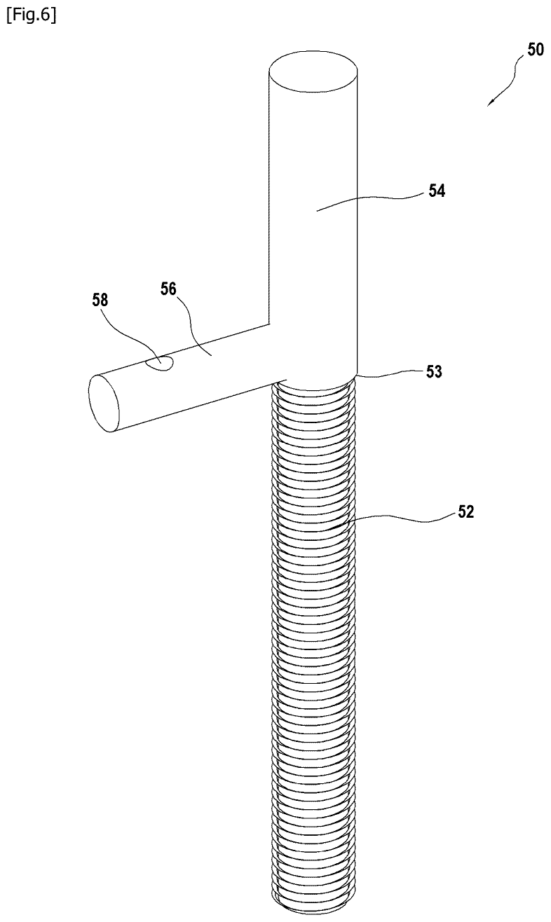

As mentioned above, instead of being held directly in the channel 12, 112, the plant may be held in the planting area 18, 118 by a fixing accessory 50, one example of which is illustrated in FIG. 6. For the sake of brevity, the fixing accessory 50 will be described in the context of the pot 10 according to the first embodiment, but the fixing accessory 50 can also be used in other embodiments, such as the pot 110 according to the second embodiment.

As illustrated in FIG. 6, the fixing accessory 50 may comprise several branches, here rectilinear branches. An attachment branch 52, here forming a lower branch, is configured to attach the fixing accessory 50 to the pot 10, in this case to the core 30. More specifically, the attachment branch 52 may cooperate with the fixing means 32 previously described, for example be threaded to be screwed into the corresponding tapping of the core 30. A stop 53 may be provided to locate and control the correct driving of the fixing accessory 50 in the core 30. The attachment branch 52 may cooperate with the entire tapping, as illustrated, or be shorter than the tapping.

If necessary, the fixing accessory 50 may further comprise a stake branch 54, here forming an upper branch. The stake branch 54 may be vertical in the position of use of the pot 10 and of the fixing accessory 50, in order to serve as a stake for the plant. Furthermore, the stake branch 54 may facilitate the manipulation of the pot 10 from above.

The fixing accessory 50 may further comprise a holding branch 56, here forming a lateral branch. The holding branch 56 includes a means for holding a pre-germinated plant, in this case an orifice 58, provided to open out facing the planting area 18. The space between the holding branch 56 and the channel 12 may be used to manage the bulkiness of the rooting development just around the seed at an advanced stage of development, where appropriate. Moreover, this space, calibrated thanks to the stop 53, may be dimensioned so that the roots are in contact with the fluid circulating in the channel 12 although the seed itself is raised relative to the channel 12.

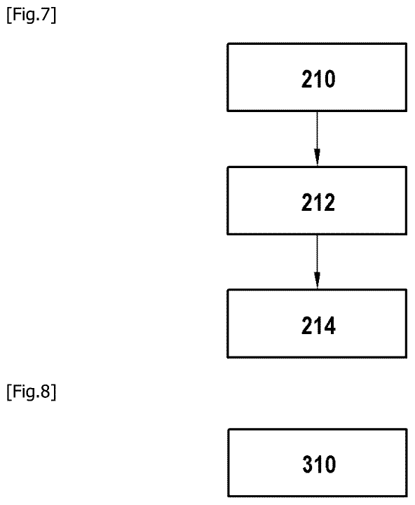

FIG. 7 schematically illustrates a method for cultivating a plant according to one embodiment, which may use the pot according to any one of the variants described above, for example the pot 10. The method comprises planting 210 a plant in the planting area 18 of the pot 10, then supplying 212, continuously or intermittently, the inlet 14 of the channel 12 with fluid. The fluid arriving via the inlet 14 is filled, where appropriate, with nutrients upon contact with the water-soluble filler, then travels through the channel 12 to the outlet 16 while irrigating in the process the roots of the plant. The fluid is discharged at the outlet 16 and may or may not be returned to the inlet 14, optionally after one or several physical, chemical and/or biological treatments.

The plant can thus grow, until the time when its growth is deemed sufficient. This may correspond to the time when the plant has reached the seed-setting stage, and/or to the time when the plant or its fruit is considered to have reached maturity for consumption, in particular by humans. Following its reproduction and/or harvest, what remains of the plant in the pot may be cleaned and discharged during a cleaning 214. This discharged part of the plant may possibly be reprocessed in order to recover its nutrients. For example, this part may be reconditioned into a water-soluble filler that will be used for the growth of a subsequent plant.

In the case of the pot 110 according to the second embodiment, where the interior of the channel 112 is less accessible, the cleaning may be carried out by screwing inside the channel 112 a turn whose shape is complementary to that of the channel 112, so that this turn pushes the remaining debris towards the other end of the channel 112.

FIG. 8 schematically illustrates a method for manufacturing a pot according to any one of the previously described variants, the method comprising making 310 the pot by additive manufacturing. For example, the regolith/PHA matrix previously described may be printed at a temperature comprised between 20° and 300° C., which could allow destroying the perchlorates previously mentioned and thus reducing or eliminating the toxicity of the regolith.

The additive manufacturing based on a material comprising regolith has the advantage of being able to be implemented directly in space, with the materials present on satellites such as the Moon, or even other planets. However, applications are also present on Earth, optionally with other materials such as resins, for markets such as urban farms or the like. Additive manufacturing makes it possible to easily manufacture the pot 110 whose channel 12 section is closed. However, the pot 10 may be made by other means, for example by injection and/or machining. Furthermore, these pots are here manufactured in a single piece thanks to additive manufacturing, but they could also be manufactured in several pieces assembled together by usual manufacturing techniques.

Among the additive manufacturing methods mentioned above, fused deposition modeling allows printing different materials, while stereolithography and selective laser sintering are currently single-material technologies.

Although the present description refers to specific exemplary embodiments, modifications can be made to these examples without departing from the general scope of the invention as defined by the claims. Furthermore, individual characteristics of the different embodiments illustrated or mentioned can be combined in additional embodiments. Consequently, the description and the drawings should be considered in an illustrative rather than restrictive sense.

1. A pot for cultivating a plant, comprising a planting area and a root guide channel extending between a fluid inlet and a fluid outlet and configured to guide the development of roots downstream of the planting area, said channel being accessible to the roots of a plant planted in the planting area, the channel winding around a guideline and making more than one revolution around said guideline between the inlet and the outlet, and the channel having a porous bottom.

2. The pot according to claim 1, wherein the planting area is located along the channel, between the inlet and the outlet.

3. The pot according to claim 1, wherein the channel is provided with a holder for retaining a water-soluble filler.

4. The pot according to claim 1, wherein the planting area is provided closer to the guideline than to an outside of the pot.

5. The pot according to claim 1, wherein the channel is configured to allow a gravity flow of liquid between the inlet and the outlet.

6. The pot according to claim 1, wherein, with reference to a radius—azimuth—dimension reference frame having the guideline as axis, a parameterization of the channel is such that the azimuth takes a same value several times and the dimension evolves in a monotonic manner.

7. The pot according to claim 1, wherein the channel has a general helix shape.

8. The pot according to claim 1, further comprising a core extending along the guideline.

9. The pot according to claim 8, wherein at least one end of the core includes a fastener.

10. The pot according to claim 1, wherein the channel has a closed cross-section, or wherein the channel is, in cross-section, open opposite to the bottom.

11. The pot according to claim 1, further comprising an instrument configured to monitor or stimulate the growth of the plant.

12. A method for cultivating a plant, comprising planting the plant in the planting area of the pot according to claim 1, and supplying the inlet of the channel with fluid, so that the fluid flows towards the outlet while reaching the roots of the plant.

13. The cultivation method according to claim 12, wherein the supplying is intermittent.

14. A method for manufacturing the pot according to claim 1, comprising making the pot by additive manufacturing.

15. An assembly for cultivating a plant, comprising the pot according to claim 1, and a base on which the pot is detachably mounted.

16. The pot according to claim 3, wherein the holder is located between the inlet and the planting area.

17. The pot according to claim 8, wherein the core supports the channel.

18. The pot according to claim 9, wherein the fastener comprises at least one of a thread or a tapping.

19. The pot according to claim 11, wherein the instrument includes at least one of an image sensor, a lighting element or a microfluidic chip.
